(19) United States
(12) Patent Application Publication
(10) Pub. No.: US 2004/0267675 A1
(43) Pub. Date: Dec. 30, 2004

(54) Method and system for custom selection and packaging of items to fulfill customer orders

(76) Inventors: David J. Burton, Toronto (CA); Edward J. Burton, New Market (CA); Gloria MacDonald, Toronto (CA); Brendan W. Szemplinski, Stamford, CT (US); Joel Yoffee, Ringwood, NJ (US)

Correspondence Address: JEFFREY L. BRANDT, c/o PORTFOLIO IP, P.O. BOX 52050, MINNEAPOLIS, MN, 55402, US

(21) Appl. No.: 10/612,283

(22) Filed: Jun. 30, 2003

(51) Int. Cl. G06F 17/60

(52) U.S. Cl. 705/400

(57) ABSTRACT

There is provided herein methods and systems for fulfilling customer orders by mail in a timely and cost-effective manner. Items to be included in the order are custom-selected based on characteristics such as weight and/or size to minimize postage cost. Customer orders too large to take advantage of discounted postal rates are parsed into multiple mailings, each mailing taking advantage of reduced postal rates, the multiple mailings together fulfilling the customer order.

Customer order data processing may be remotely handled at any convenient location. Custom item selection and packaging is handled in a fast, highly-automated manner by a computer-controlled, assembly-line machine. The customer is automatically notified on each mailing if the order has been packaged and mailed in multiple mailings.

### FIELD OF THE INVENTION

This invention relates generally to package handling and mailing and more particularly to the custom selection and packaging of items to fulfill customer orders through cost- effective mailing.

### BACKGROUND OF THE INVENTION

Today many commercial items are delivered to customers through the United States and/or other national mail systems. A very small list of exemplary commercial items includes magazines, CD's and DVD's, clothing, and others. The postal rates applied to these items are, in contrast to first class rates, lower commercial rates. These commercial rates vary substantially depending on the weight and size of the mailing.

Different systems are known for controlling the cost of postage with respect to characteristics of commercial items. U.S. Pat. Nos. 4,639,873 and 5,177,687, both to Baggarly et al., show insertion machines with postage categorization wherein necessary items are inserted into a mailing on an assembly-line basis, the items selected determined by indicia printed on a master control item. The weight of these necessary items is known as are the weights of optional items. Selected optional items are inserted into the mailing only if doing so will not increase the postage rate. U.S. Pat. No. 4,959,795 to Christensen et al. shows a system similar to that of Baggarly et al. with the inclusion of chargeback capability to apportion and charge back the costs of added mail insertions, including additional postage, to appropriate parties.

U.S. Pat. No. 6,135,292 to Pettner shows a system wherein the thicknesses of items to be mailed are measured and the items are presorted based on thickness to take advantage of postal discounts.

Many other systems are known for creating mailings, each responsive to some perceived need of the inventor. For example, U.S. Pat. No. 5,659,481 describes an electro-mechanical system for inserting enclosures into mailed statements. U.S. Pat. No. 5,918,220 to Sansone et al. shows a system for producing a mail piece at a remote location so as to give the appearance to the recipient of locally generated mail. U.S. Pat. No. 5,774,885 to Delfer, III shows a system for combining multiple individual statements into a single mailing envelop.

While many different systems are known for creating mailings and particularly for minimizing the postage associated with mailings by activities such as weight control, thickness/size control and/or presorts, no system is known to the present inventors for managing the creation and mailing of a customer-submitted order in an automated, cost-effective manner. In contrast to the systems of Baggarly et al., responses to customer orders must by definition include every item selected by the customers. No item can be optionally omitted. In contrast to Christensen et al. described above, it is desirable to complete such customer orders without incurring unnecessary postage costs. In fact, there may be no third-party to apportion additional mailing costs back to as taught by Christensen et al.

There thus exists a need for systems and methods for fulfilling customer orders which enable the entire order to be fulfilled in a timely and cost-effective manner.

### SUMMARY OF THE INVENTION

There is provided herein methods and systems for fulfilling customer orders by mail in a timely and cost-effective manner. Items to be included in the order are custom-selected based on characteristics such as weight and/or size to minimize postage cost. In accordance with a key feature of the invention, customer orders can be parsed into multiple mailings, each mailing taking advantage of reduced postal rates, the multiple mailings together fulfilling the customer order.

In accordance with other features of the invention, customer order data processing may be remotely handled at any convenient location. Custom item selection and packaging is handled in a fast, highly-automated manner by a computer-controlled machine. The system further includes the ability to efficiently and automatically notify the customer that the order has been packaged and mailed in multiple mailings.

In accordance with one embodiment of the invention there are provided methods and systems for selecting and packaging items for mailing, a method comprising the steps of: receiving a customer order specifying a plurality of items for shipping by mail; retrieving a selected characteristic for each of the plurality of items; determining, based on the selected characteristic, if a single package containing the plurality of items will exceed a desired postal rate; if the single package will not exceed the desired postal rate, packaging the plurality of items in a single package; if the single package will exceed the desired postal rate, dividing, based on the selected characteristic, the customer order into multiple sub-orders, each sub-order including a subset of the plurality of items selected so that the sub-order will be at the desired postal rate, printing a mailer including a control indicia on the mailer, automatically selecting, based on the control indicia, items for inclusion in each sub-order, and packaging each of the sub-orders individually so that the customer order comprises multiple packages; and mailing the single or multiple packages to the customer.

In accordance with another embodiment of the invention there are provided methods and systems for selecting and packaging items for mailing, comprising the steps of: receiving a customer order specifying a plurality of items for shipping by mail; determining, based on a selected characteristic for each of the plurality of items, if a single package containing the plurality of items will exceed a desired postal rate; if the single package will not exceed the desired postal rate, packaging the plurality of items in a single package; if the single package will exceed the desired postal rate, dividing, based on the selected characteristic, the customer order into multiple sub-orders, each sub-order including a subset of the plurality of items selected so that the sub-order will be at the desired postal rate, packaging each of the sub-orders individually so that the customer order comprises multiple packages; and mailing the single or multiple packages to the customer.

In accordance with another embodiment of the invention there are provided methods and systems for selecting and packaging items for mailing, comprising the steps of: receiving a customer order specifying a plurality of items for shipping by mail; determining, based on a selected characteristic or each of the plurality of items, if a single package containing the plurality of items will exceed a desired postal rate; if the single package will not exceed the desired postal rate, printing a single mailer including a control indicia for operating a machine to place the plurality of items into a single package; if the single package will exceed the desired postal rate, printing a plurality of mailers, each of the plurality of mailers including a control indicia for operating a machine to place a selected subset of the plurality of items into a package, the multiple packages associated with the plurality of mailers together fulfilling the customer order.

### DESCRIPTION OF THE DRAWING FIGURES

These and other objects, features and advantages of the invention will be apparent from a consideration of the detailed description of the invention below when read in consideration of the drawing figures, in which:

FIG. 1 is a block diagram showing the various parties associated with the present invention and their various communications channels;

FIG. 2 is a block diagram showing the details of the data processing center of FIG. 1;

FIG. 3 is a table showing exemplary postal rate data stored in the database of FIG. 2;

FIG. 4 is a table showing exemplary customer order data stored in the database of FIG. 2;

FIG. 5 is a table showing exemplary item characteristics data stored in the database of FIG. 2;

FIG. 6 is a block diagram showing the details of the fulfillment center of FIG. 1;

FIG. 7 is a block diagram showing the mailer of FIG. 6 before packaging;

FIG. 8 is a block diagram showing the mailer of FIG. 6 after packaging;

FIG. 9 is a flow chart showing an overview of an order fulfillment process in accordance with the present invention;

FIG. 10 is a flow chart showing the customer order obtainment process from FIG. 9;

FIG. 11 is a flow chart showing customer order data processing;

FIG. 12 is a flow chart showing the order fulfillment process of FIG. 9; and

FIG. 13 is a flow chart showing the package calculation process of FIG. 12.

### DETAILED DESCRIPTION OF THE INVENTION

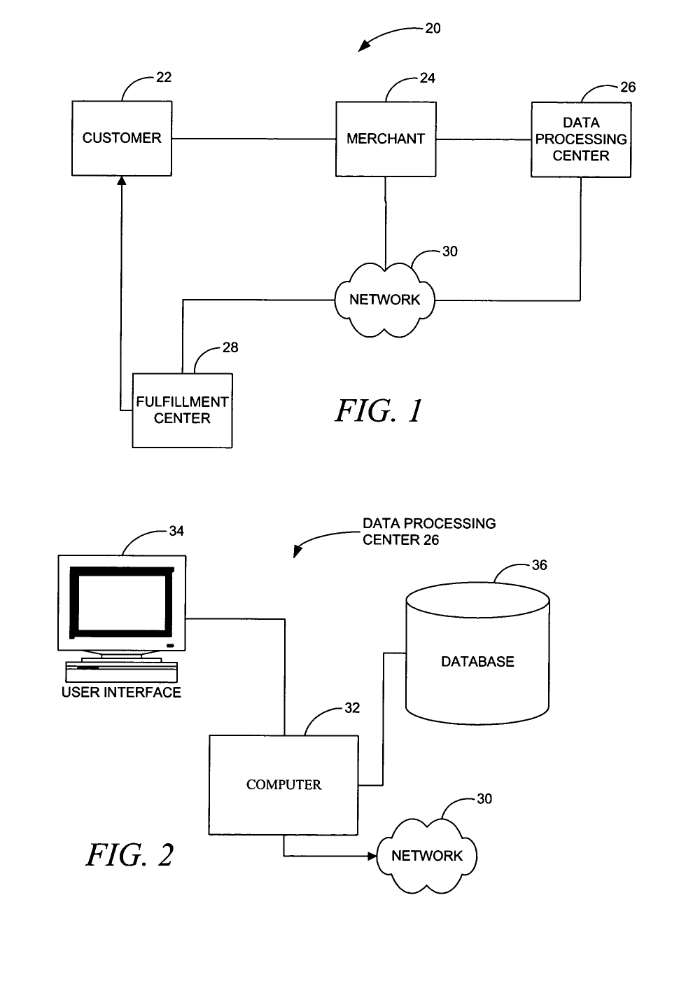

With reference now to FIG. 1, there is shown a system 20 including a customer 22, a merchant 24, a data processing center 26 and a fulfillment center 28 interconnected through a network 30 such as the Internet. Merchant 24 comprises, for example, a financial services institution or any other institution that communicates regularly with customers such as customer 22. Customer 22 comprises a conventional customer of merchant 24. Data processing center 26 and fulfillment center 28 are as described in detail below.

The various parties in FIG. 1 are connected to communicate electronically with one another through the Internet 30. Additionally, customer 22 and merchant 24 communicate by mail, as do the customer and fulfillment center 28, in the manner described below.

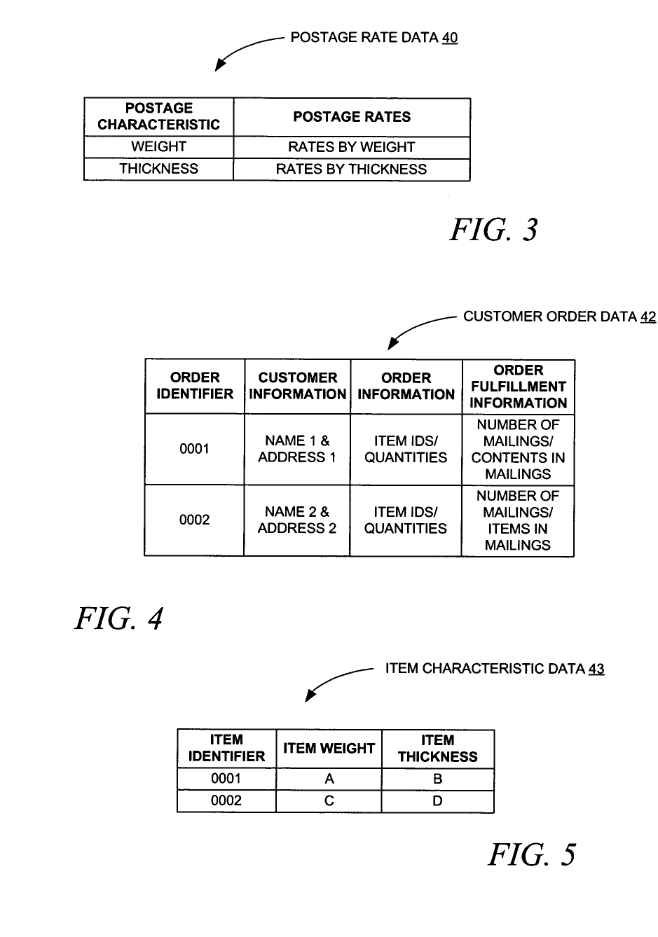

With reference now to FIG. 2, data processing center 26 is seen to include a conventional computer 32 connected to a conventional user interface 34, a database 36 and to network 30. References to like elements are by same reference numbers. Computer 32 can be any conventional computer, for example a personal computer, server or a mainframe computer, running the processes described below. Database 36 comprises any conventional data storage containing the data as described herein and software for performing the steps described below. In particular, database 36 contains postal rate data and customer order data as described with respect to FIGS. 3 and 4 below. Likewise, user interface 34 comprises any conventional user interface, for example including a keyboard, display, and compact disc (cd) and/or digital video disc (dvd) and/or other data input/output device(s).

With reference now to FIG. 3, postage rate table 40 contained in database 36 is seen to include postage rates based on mail package characteristics. For example, the table is seen to include postage rates based on package weight and postage rates based on package thickness. Other characteristics affecting postage rates will be known to those skilled in the art.

With reference now to FIG. 4, a customer order data table 42 contained in database 36 is seen to include data relating to customer orders. Each customer order entry, that is each row of data, is seen to include an order identifier, customer information such as name, address and other related information, order information including the items and quantities of items ordered and order fulfillment information including the number of mailings and items in each mailing in the manner described below.

With reference now to FIG. 5, an item characteristic data table 43 contained in database 36 is seen to include characteristics relating to items to be mailed, and more particularly characteristics relevant to the postal rates of FIG. 3. Each item entry, that is each row of data, is seen to include a weight and thickness that can be used to determine postal mailing costs.

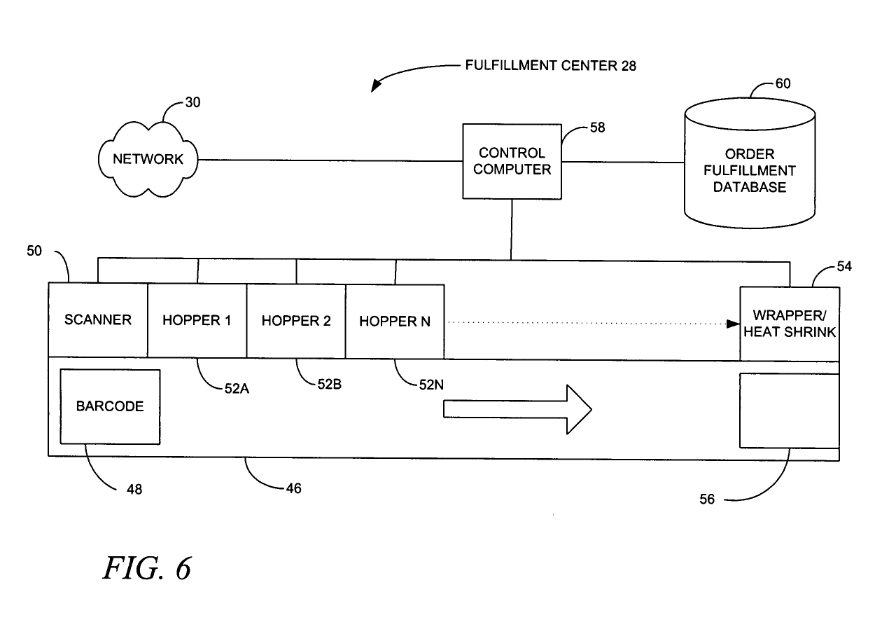

With reference now to FIG. 6, fulfillment center 28 (see also FIG. 1) is seen to include an assembly line conveyor belt 46 connected to convey a mailing label 48 past a linear array of machines including a bar-code scanner 50, a series of N hoppers 52A-N and eventually a packaging station 54 to provide a package 56 for mailing. A control computer 58 is connected to network 30, an order fulfillment database 60 and to each of the conveyor belt 46, scanner 50, hoppers 52A-N and packaging station 56. Control computer 58 preferably includes a conventional user interface (not shown) for administering it's operation.

Control computer 58 comprises any conventional personal computer, server or mainframe computer connected to control the operation of the scanner, hoppers and packaging station as described below. Order fulfillment database 60 comprises any conventional database for storing the customer order data 42 as shown in FIG. 4 and software instructions for performing the steps described below.

In the described embodiment, each of hoppers 52A-N contains a stack of a particular compact disc (CDs) or digital video disc (DVDs) to be mailed to fulfill customer orders, as well as an electro-mechancial device for inserting the items onto mailer 48 in the manner described below. Packaging station 54 comprises a shrink-wrap packaging station for shrink-wrap packaging the selected CD and DVD items stacked on belt 46 by hoppers 52A-N. Many such hoppers are well known in the art.

Similarly, bar-code scanner 50 and heat-wrap packaging station are conventional, commercially available units well known to those of ordinary skill in the art.

It will be understood that the invention is not limited to CDs and/or DVDs and the mechanisms for packaging same, but to any items which can be processed in accordance with the methods described herein below. Exemplary items in addition to those described include: brochures, books, card packs, clothing items and any other item wherein groups of the same item have similar characteristics such as size or weight and are capable of automated handling in the described manner.

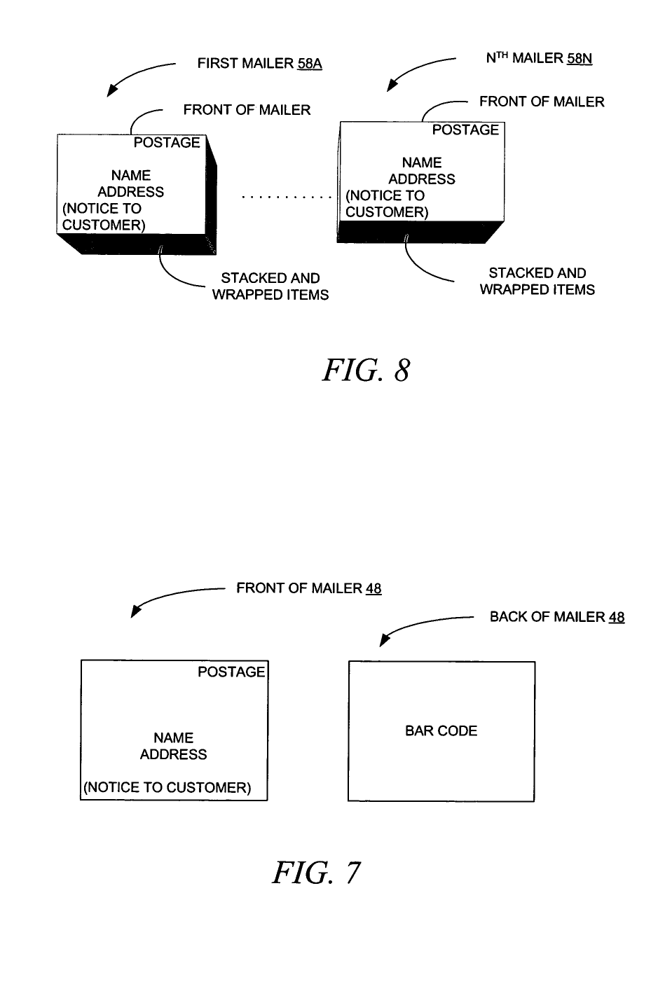

With reference now to FIG. 7, the front and back of mailer 48 (FIG. 6) is shown before the mailer is packaged for shipping. As shown, the front includes appropriate postage, a customer address and a notice to the customer, for example that the customer order has been shipped in multiple shipments. The back contains a bar code as further described below.

FIG. 8 shows a first mailer 58A and an N^{th} mailer 58N, the mailers together comprising a single customer order packaged as a plurality of sub-orders in the manner described below. The front of each mailer includes the information described in FIG. 7 above. The barcode on the back of each mailer is covered by stacked items as described below. Each mailer is shrink-wrapped in plastic for mailing in a selected national postage system or with a private mailing service.

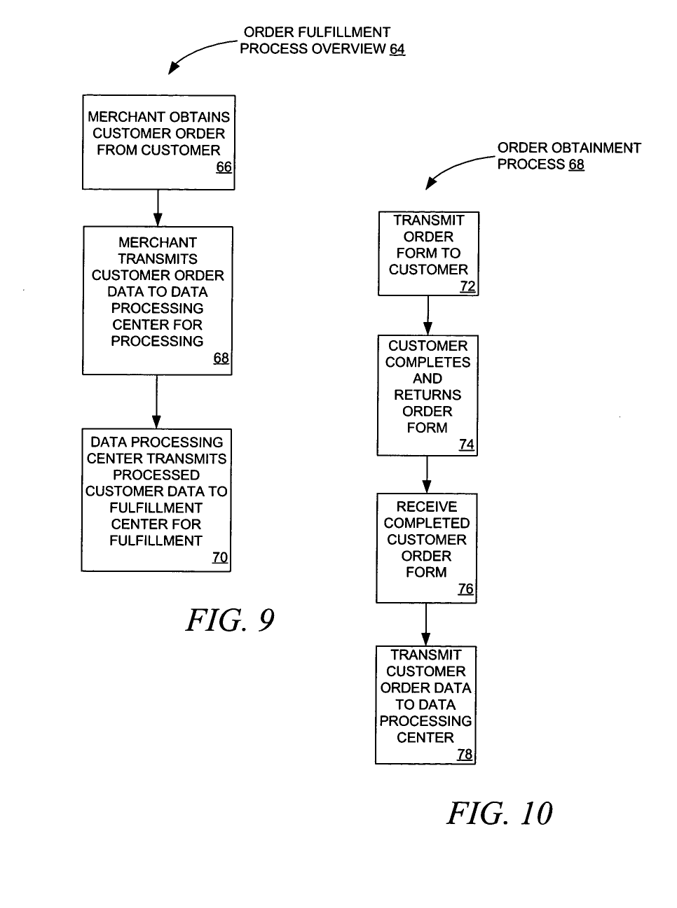

With reference now to FIG. 9, an order fulfillment process 64 is shown at an overview level wherein initially a customer order, including order data, is obtained (step 66) by merchant 24 from customer 22 (FIG. 1). Subsequently the customer order is provided to data processing center 26 (FIG. 1) for processing (step 68) and data processing center 26 transmits the processed customer order data to fulfillment center 28 (FIG. 6) for fulfillment (step 70). Each of these process steps is described in further detail herein below.

With reference now to FIG. 10, in the described embodiment, customer order obtainment process (step 68 of FIG. 9) is done by United States postal mail. In this described embodiment, a customer order form is mailed from merchant 24 to customer 22, for example included in a customer bill or statement (step 72). Alternatively, the order form may be provided in any other acceptable manner including, for example, by facsimile, electronic file transmission, or customer order data may be collected by telephone through a live operator or automated answering service. As described above, in the present embodiment the order form enables the customer to select desired CDs and/or DVDs.

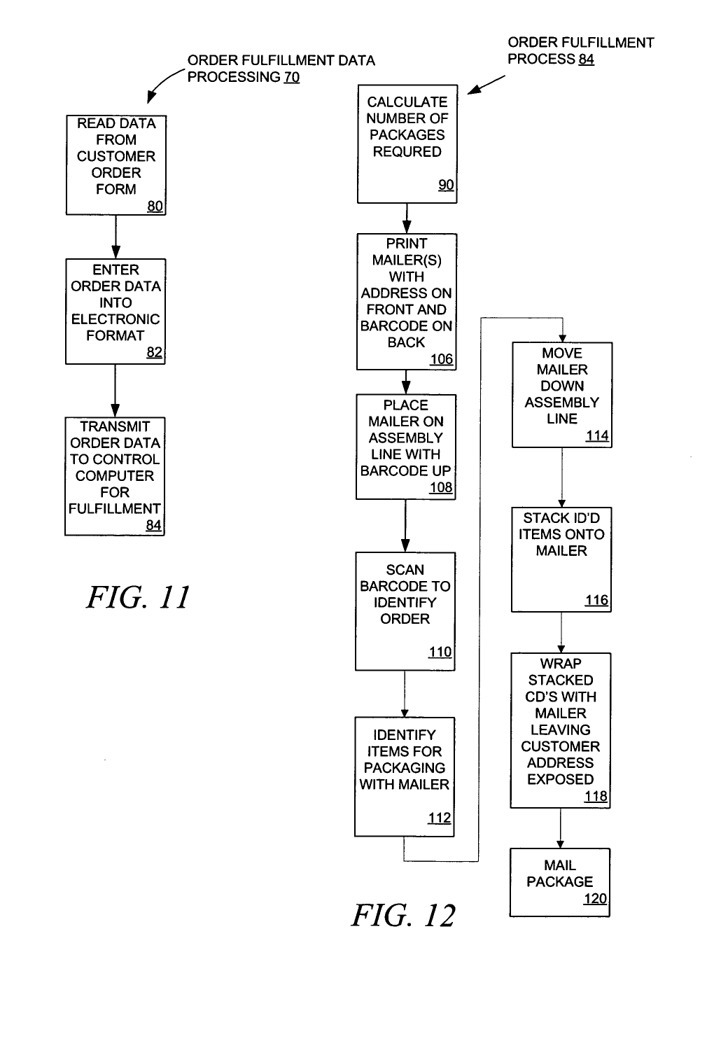

The customer completes the order form (step 74) and returns it by mail to the merchant (step 76). Again, the order form may be completed and returned by many other obvious means such as facsimile or electronically, or the order data provided by telephone. The customer order data is collected by merchant 24 and transmitted (step 78) to data processing center 26 (FIG. 1), for example by mail, for processing as described below. With reference now to FIG. 11, the customer order data processing (step 68 of FIG. 9) is shown wherein the customer order data is read from the customer form (step 80), entered into computer 32 (step 82) and transmitted, for example over Internet 30, to fulfillment center 28 (step 84). It will be understood that as a result of this data processing, table 42 (FIG. 4) has been populated with the exception of the order fulfillment information. Table 42 thusly resides in database 36 of data processing center 26 and also in order fulfillment database 60.

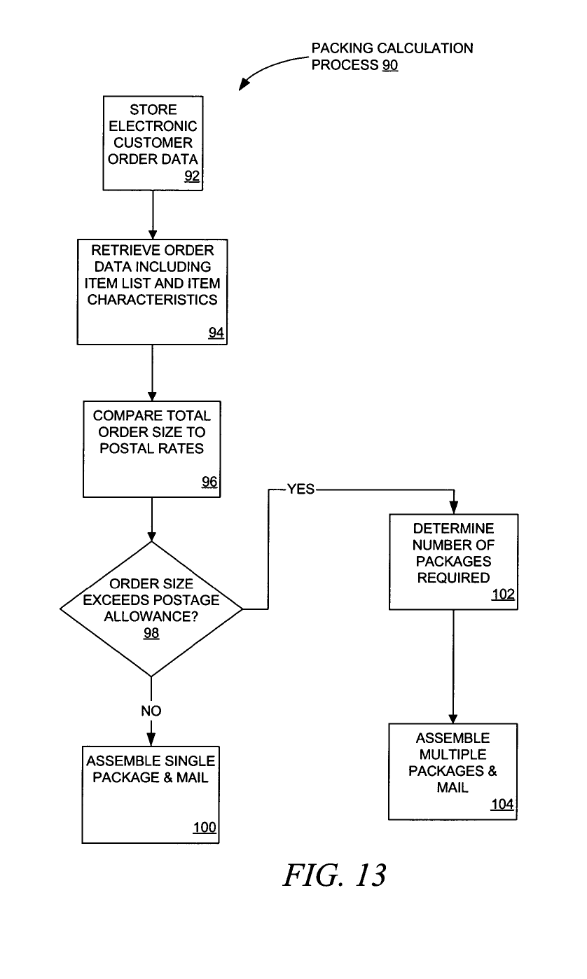

With reference now to FIG. 12, order fulfillment process 84 is shown wherein initially there is calculated the number of packages necessary to fulfill a customer order (step 90). With reference now to FIG. 13, package calculation process 90 is seen to include receiving the electronic customer order data from data processing center 26. As noted above, the customer order data includes at least the order information contained in table 42 of FIG. 4, i.e. the customer information and items ordered, less the fulfillment data still to be calculated. This data is stored in fulfillment center database 60 (step 92) with the described processing performed by control computer 58.

Continuing with reference to FIG. 13, subsequently, the list of ordered items is retrieved from the customer order data and the pertinent mail characteristics for each ordered item are retrieved from table 43 (step 94). The pertinent postal data is retrieved from table 40, and the total items in the customer order are considered to determine if a single package would exceed the desired postal rates (step 96). For example, assuming that CDs and DVDs are being mailed, it is likely that the determining characteristic for postage would be weight. Thus, the weight of each ordered item is retrieved and the total weight calculated to see if it exceeds the maximum weight for the desired postal class and rate. For items where thickness or other size measurements or other characteristics are determinative of postal rates, the determinative characteristic(s) would be retrieved for each item and totaled.

If a single package can be assembled and mailed at the desired postal rate (step 98), then those steps are performed (step 100, returning to step 106 of FIG. 12). If a single package cannot be assembled and mailed at the desired postal rate (step 98), then the number of packages including the exact item contents of each package is determined (step 102), and the package is assembled and mailed (step 104, returning to step 106 of FIG. 12). Many different methods will be readily apparent for determining how to assemble groups of items within the desired postal rate. For example, a sub-order of items may simply be selected in order from a list until the maximum characteristic, i.e. weight, is reached, then a new sub-order started. Other more complex methods may be used to group items by the appropriate characteristic. Still other more complex methods may be used to group items both by a first characteristic relevant to postal rates and a second characteristic not relevant to postal rates but otherwise relevant to fulfilling the customer order, for example a second characteristic based on grouping similar types of items.

With reference back to FIG. 12, once the total number of packages/mailings is determined to fulfill a customer order (FIG. 13), that data is stored in database 60 in the field shown in table 42 (FIG. 4) and the necessary number of mailers 48 (see FIG. 7) are printed (step 106). Each mailer 48 includes, on its back, a bar code, the bar code keyed to the order fulfillment information in database 60, each bar code thus describing the exact item selection to be packaged for its particular mailing. On its front, each mailer 48 includes the customer name and address, postage, and if the customer order is to be fulfilled in multiple packages, a notice to the customer indicating same.

Continuing with respect to FIG. 12, each printed mailer is placed on assembly line 46 (FIG. 5) with the barcode up so as to be readable by scanner 50 (step 108). Scanner 50 scans the barcode on mailer 48 so as to identify the order fulfillment data (step 110) including the exact items to be packaged with that mailer (step 112). As the mailer proceeds down assembly line 46 (step 114), responsive to the barcode scanning, control computer 58 operates the appropriate hoppers 52A-N to stack the selected items for that mailing directly onto the mailer (step 116). As the mailer and stacked items reach packing station 54, they are shrink-wrapped in plastic in a conventional manner leaving the customer address, postage and any customer notice exposed on the face of the mailer (step 118). As described above, FIG. 8 shows multiple packages, stacked and wrapped, the group 58A-N comprising a single customer order. As described above, a notice is included on the front of the mailer informing the customer that the order will arrive in multiple packages.

Finally, the assembled packages are mailed in a selected public or private postal system (step 120).

In an alternate embodiment of the invention, the packing calculation process shown in FIG. 13 is performed by computer 32 in data processing center 26 and the order fulfillment data determined, stored in table 42 and transmitted to order fulfillment database 60 in fulfillment center 28. In this alternate embodiment control computer 58 retrieves the pre-calculated order fulfillment data from order fulfillment database 60 and the process otherwise proceeds as described above.

There has thus been provided methods and systems for automated and cost-effective processing of customer orders requiring fulfillment with multiple, customer-selected items. The invention provides, in a customized manner for each customer order, item selection for multiple packages to take advantage of lowest commercial postal rates. The invention further provides for the automatic and fast packing and wrapping of each package in an assembly-line type environment. When multiple packages are used to fulfill a single' customer order, notice of the multiple mailings is provided to the customer on each mailing.

What is claimed is:

1. A method operable on a computer for selecting and packaging items for mailing, comprising the steps of:
receiving a customer order specifying a plurality of items for shipping by mail;
retrieving a selected characteristic for each of the plurality of items;
determining, based on the selected characteristic, if a single package containing the plurality of items will exceed a desired postal rate;
if the single package will not exceed the desired postal rate, packaging the plurality of items in a single package;
if the single package will exceed the desired postal rate,
dividing, based on the selected characteristic, the customer order into multiple sub-orders, each sub-order including a subset of the plurality of items selected so that the sub-order will be at the desired postal rate,
printing a mailer including a control indicia on the mailer,
automatically selecting, based on the control indicia, items for inclusion in each sub-order, and
packaging each of the sub-orders individually so that the customer order comprises multiple packages; and
mailing the single or multiple packages to the customer.

2. A method in accordance with claim 1 wherein the customer order is received by mail on a pre-printed form.

3. A method in accordance with claim 1 wherein the selected characteristic is chosen from the group comprising: item weight, item thickness and item size.

4. A method in accordance with claim 1 wherein the step of packaging each of the sub-orders comprises the steps of:
printing a mailer for each sub-order;
placing each mailer on an assembly line; and
placing each item in each sub-order on the associated mailer as the mailer traverses the assembly line.

5. A method in accordance with claim 4 wherein:
each mailer comprises a printed paper mailer;
each paper mailer includes, on a first side, a bar code indicative of the items to be packaged with the mailer and on a second side a customer address.

6. A method in accordance with claim 5 wherein the assembly line comprises:
a scanner for reading the bar code on each mailer;
a plurality of hoppers, each hopper containing a plurality of like items; and
a mechanism responsive to computer control for moving an item from a hopper onto a mailer.

7. A method in accordance with claim 6 and further including a customer message on the front of a mailer readable by a customer and indicating that a customer order has been fulfilled in multiple packages.

8. A method in accordance with claim 7 wherein the step of packaging each of the sub-orders includes shrink-wrapping each of the sub-orders in a plastic wrap so that the customer address and customer message are readable through the plastic wrap.

9. A method in accordance with claim 1 wherein the step of receiving a customer order is performed at a location geographically remote from the step of packaging each of the sub-orders.

10. A system for selecting and packaging items for mailing, comprising:
a processor;
a memory connected to the processor, the memory storing data and instructions for controlling the operation of the processor;
the processor operative to perform the steps of
receiving a customer order specifying a plurality of items for shipping by mail;
retrieving, from the memory, a selected characteristic for each of the plurality of items;
determining, based on the selected characteristic, if a single package containing the plurality of items will exceed a desired postal rate;
if the single package will not exceed the desired postal rate, packaging the items in a single package;
if the single package will exceed the desired postal rate,
dividing, based on the selected characteristic, the customer order into multiple sub-orders, each sub-order including a subset of the plurality of items selected so that the sub-order will be at the desired postal rate,
printing a mailer including a control indicia on the mailer,
automatically selecting, based on the control indicia, items for inclusion in each sub-order, and
packaging each of the sub-orders individually so that the customer order comprises multiple packages; and
mailing the single or multiple packages to the customer.

11. A system in accordance with claim 10 wherein the customer order is received by mail on a pre-printed form.

12. A system in accordance with claim 10 wherein the selected characteristic is chosen from the group comprising: item weight, item thickness and item size.

13. A system in accordance with claim 10 further including an assembly line and wherein the step of packaging each of the sub-orders comprises the steps of:
printing a mailer for each sub-order;
placing each mailer on the assembly line; and
placing each item in each sub-order on the associated mailer as the mailer traverses the assembly line.

14. A system in accordance with claim 13 wherein:
each mailer comprises a printed paper mailer;
each paper mailer includes, on a first side, a bar code indicative of the items to be packaged with the mailer and on a second side a customer address.

15. A system in accordance with claim 14 wherein the assembly line comprises:
a scanner for reading the bar code on each mailer;
a plurality of hoppers, each hopper containing a plurality of like items; and
a mechanism responsive to computer control for moving an item from a hopper onto a mailer.

16. A system in accordance with claim 15 and further including a customer message on the front of a mailer readable by a customer and indicating that a customer order has been fulfilled in multiple packages.

17. A system in accordance with claim 16 wherein the step of packaging each of the sub-orders includes shrink-wrapping each of the sub-orders in a plastic wrap so that the customer address and customer message are readable through the plastic wrap.

18. A system in accordance with claim 10 wherein the step of receiving a customer order is performed at a location geographically remote from the step of packaging each of the sub-orders.

19. A method for selecting and packaging items for mailing, comprising the steps of:
receiving a customer order specifying a plurality of items for shipping by mail;
retrieving a selected characteristic for each of the plurality of items;
determining, based on the selected characteristic, if a single package containing the plurality of items will exceed a desired postal rate;
if the single package will not exceed the desired postal rate, packaging the items in a single package;
if the single package will exceed the desired postal rate,
dividing, based on the selected characteristic, the customer order into multiple sub-orders, each sub-order including a subset of the plurality of items selected so that the sub-order will be at the desired postal rate,
printing a mailer including a control indicia on the mailer,
automatically selecting, based on the control indicia, items for inclusion in each sub-order, and
packaging each of the sub-orders individually so that the customer order comprises multiple packages; and
mailing the single or multiple packages to the customer.

20. A system for selecting and packaging items for mailing, comprising:
means for receiving a customer order specifying a plurality of items for shipping by mail;
means for retrieving a selected characteristic for each of the plurality of items;
means for determining, based on the selected characteristic, if a single package containing the plurality of items will exceed a desired postal rate;
means for, if the single package will not exceed the desired postal rate, packaging the items in a single package;
means for, if the single package will exceed the desired postal rate,
dividing, based on the selected characteristic, the customer order into multiple sub-orders, each sub-order including a subset of the plurality of items selected so that the sub-order will be at the desired postal rate,
printing a mailer including a control indicia on the mailer,
automatically selecting, based on the control indicia, items for inclusion in each sub-order, and
packaging each of the sub-orders individually so that the customer order comprises multiple packages; and
means for mailing the single or multiple packages to the customer.

21. A method operable on a computer for selecting and packaging items for mailing, comprising the steps of:
receiving a customer order specifying a plurality of items for shipping by mail;
determining, based on a selected characteristic for each of the plurality of items, if a single package containing the plurality of items will exceed a desired postal rate;
if the single package will not exceed the desired postal rate, packaging the plurality of items in a single package;
if the single package will exceed the desired postal rate,
dividing, based on the selected characteristic, the customer order into multiple sub-orders, each sub-order including a subset of the plurality of items selected so that the sub-order will be at the desired postal rate,
packaging each of the sub-orders individually so that the customer order comprises multiple packages; and
mailing the single or multiple packages to the customer.

22. A method operable on a computer for selecting and packaging items for mailing, comprising the steps of:
receiving a customer order specifying a plurality of items for shipping by mail;
determining, based on a selected characteristic or each of the plurality of items, if a single package containing the plurality of items will exceed a desired postal rate;
if the single package will not exceed the desired postal rate, printing a single mailer including a control indicia for operating a machine to place the plurality of items into a single package;
if the single package will exceed the desired postal rate, printing a plurality of mailers, each of the plurality of mailers including a control indicia for operating a machine to place a selected subset of the plurality of items into a package, the multiple packages associated with the plurality of mailers together fulfilling the customer order.
